(19) United States
(12) Patent Application Publication
(10) Pub. No.: US 2021/0012443 A1
(43) Pub. Date: Jan. 14, 2021

(54) SYSTEM AND METHOD FOR BLOCKCHAIN-BASED PROPERTY RENOVATION FUNDING INSPECTION AND SALE

(71) Applicant: John Davison, Phoenixville, PA (US)

(72) Inventor: John Davison, Phoenixville, PA (US)

(21) Appl. No.: 16/921,998

(22) Filed: Jul. 7, 2020

Related U.S. Application Data
(60) Provisional application No. 62/871,459, filed on Jul. 8, 2019.

(51) Int. Cl. G06Q 50/16; H04L 9/06; G06Q 40/02; G06Q 20/10

(52) U.S. Cl. CPC G06Q 50/165; H04L 9/0637; G06Q 50/167; G06Q 20/102; G06Q 40/025

(57) ABSTRACT

A system and method for on-line management of real estate purchase, renovation and sale transactions via a blockchain is described. The system includes a shared database configured to store blockchain information and input devices configured to allow renovators, lenders, vendors and inspectors to record aspects of the purchase, renovation and sale of the real estate in the blockchain.

### CROSS-REFERENCE TO RELATED APPLICATION

This application claims priority under 35 U.S.C. § 119, based on U.S. Provisional Patent Application No. 62/871,459 filed Jul. 8, 2019, the disclosure of which is hereby incorporated by reference herein.

### BACKGROUND

Nearly 200,000 U.S. homes are bought, renovated and resold each year by entrepreneurs. The process is commonly termed “flipping.” Forty percent of the transactions involve financing. Financing lets investors increase overall profits by doing more deals. However, financing costs can reduce profits by 25% per deal. There are tens of thousands of flippers, but no unified and secure platform on which entrepreneurs, lenders, tradespeople, and home buyers can track the flipping process end-to-end from initial purchase of the subject property through financing, renovation and sale to consumers. Even proven flippers with long track records are currently charged high rates and fees; lose deals due to delays in getting funds; must coordinate and pay for project inspections; pay high commissions on sales; are not rewarded for higher quality work; and pay extra interest when sales are slow.

The system described herein streamlines information flow between the various parties involved in a property flip and secures and tracks the information in a blockchain-based platform.

Blockchain technology was first used in digital currency implementations. A blockchain is a data structure that stores a list of transactions that form a distributed electronic ledger that records transactions between source identifier(s) and destination identifier(s). The transactions are bundled into blocks and every block refers back to or is linked to a prior block in the chain. Computer nodes maintain the blockchain and cryptographically validate each new block and the transactions contained in the corresponding block. This validation process includes solving a computationally difficult problem that is also easy to verify and is sometimes called a “proof-of-work.”

The integrity (e.g., confidence that a previously recorded transaction has not been modified) of the entire blockchain is maintained because each block refers to or includes a cryptographic hash value of the prior block. Once a block refers to a prior block, it becomes difficult to modify or tamper with the data (e.g., the transactions) contained therein. This is because even a small modification to the data in the last addition to the block will affect the hash value of the entire chain. Each additional block increases the difficulty of tampering with the contents of an earlier block. Thus, even though the contents of a blockchain may be available for all to see, they become practically immutable.

The identifiers used for blockchain transactions are created through cryptography such as, for example, public key cryptography. For example, a user may create a destination identifier based on a private key. The relationship between the private key and the destination identifier can later be used to provide proof that the user is associated with the output from that created transaction.

### BRIEF DESCRIPTION OF THE DRAWINGS

FIG. 1 is an exemplary system block diagram;

FIG. 2 is a diagram of exemplary transactions in the flipping process;

FIG. 3 is an exemplary loan underwriting process diagram;

FIG. 4 is an exemplary loan administration process diagram;

FIG. 5 is an exemplary remote inspection process diagram;

FIG. 6 is an exemplary vendor payment process diagram;

FIG. 7 is a block diagram of a computing system; and

FIG. 8 is a block diagram of a computing system employing blockchain.

### DETAILED DESCRIPTION OF PREFERRED EMBODIMENTS

Those skilled in the art will recognize other detailed designs and methods that can be developed employing the teachings of the present invention. The examples provided here are illustrative and do not limit the scope of the invention, which is defined by the attached claims. The following detailed description refers to the accompanying drawings. The same reference numbers in different drawings may identify the same or similar elements.

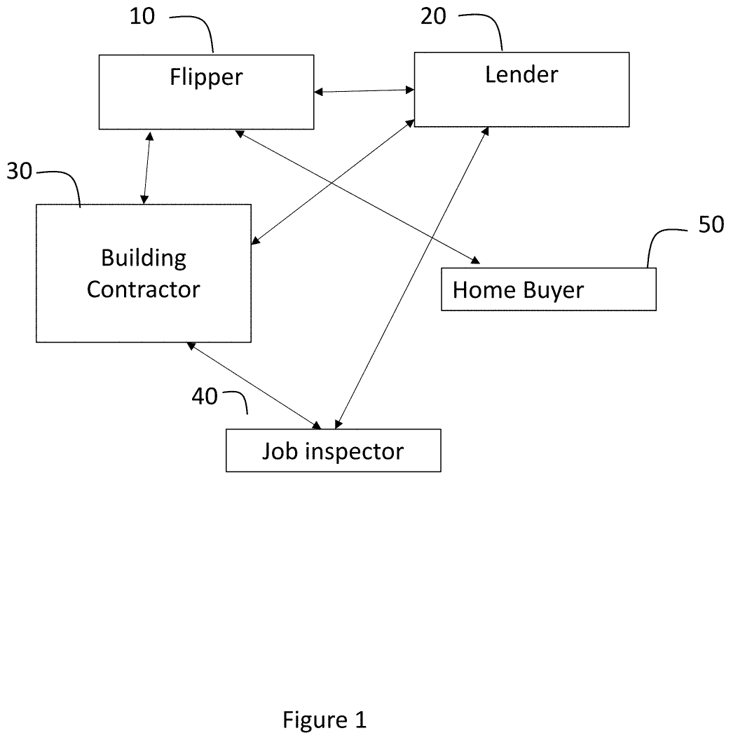

FIG. 1 is a block diagram of exemplary stakeholders in a typical property flip process. The flipper 10 must obtain financing from a lender 20 for property purchase and/or rehab construction work on the subject property. The flipper 10 engages one or more building contractors 30 to work on the property during the rehab process. The building contractors 30 may be directly paid by the lender 20 or indirectly from the lender 20 via the flipper 10. In either case, the work performed by the building contractor is typically inspected by a job inspector 40 at various stages of project completion. Payment to the building contractor 30 by the lender 20 or the flipper 10 may be contingent on milestone achievements, as verified and approved by the job inspector 40. Ultimately, the renovated property is sold by the flipper 10 to a home buyer 50.

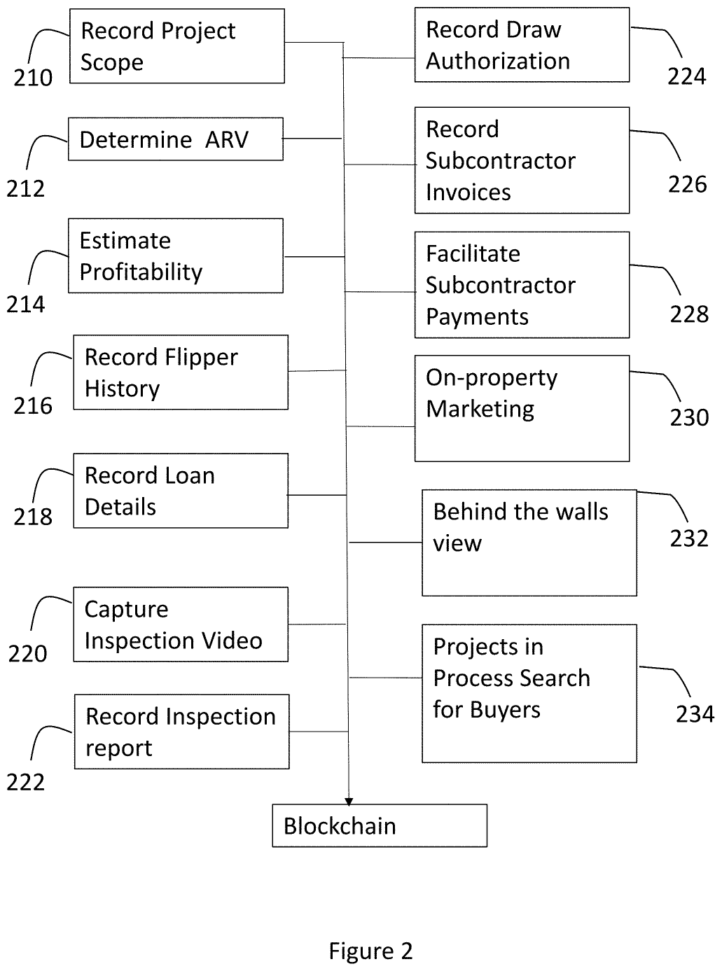

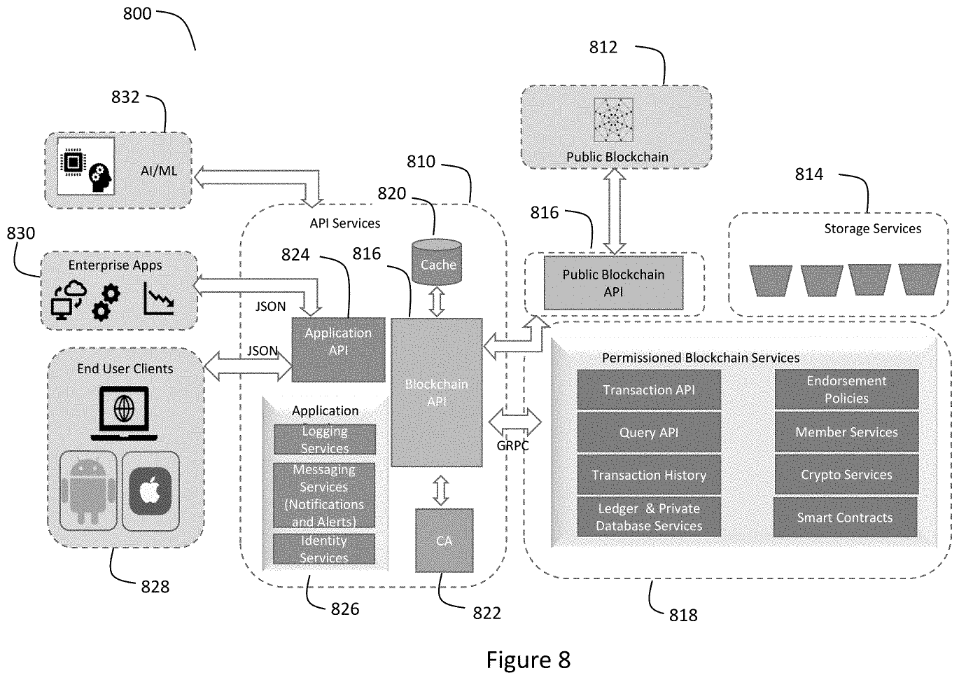

Consistent with embodiments of the invention described herein, a computer program may manage information flow between the flipper 10, the lender 20, the building contractors 30, the job inspectors 40 and the home buyer 50 such that all information is documented in a secure and verifiable process by using a block chain. The computer program may be hosted on a server and provide for user access via the internet. In a further embodiment, each stakeholder as described in FIG. 1, may access the blockchain via their own copy of the application program running on the individual stakeholder's computer. As used here, the term computer may include, for example, a desktop computer, a mobile computer such as a laptop or tablet, or a smart phone. FIG. 8 is an exemplary computing system that may be used to implement the various methods described herein. As used throughout FIGS. 2-6, the term “system” may be the system 800 of FIG. 8 or another distributed computing system.

Transactions, inspections, property access and other events are recorded in a shared, unchangeable database that eliminates disputes. The platform's trusted data speeds loan approvals and reduces costs by giving lenders trusted operator histories and financials; increases property value with proof (including video) of work that has been done; simplifies and speeds vendor payment with automatic release of funds on approval of work; and reduces risk for buyers and lenders by ensuring all vendors have been paid.

FIG. 2 shows exemplary transactions in a property flipping process. Each transaction in the process causes data to be generated that is included in a blockchain 201, thus securing and preserving the information in a manner that each stakeholder can be assured is authentic. The transactions are not described here to be performed in any particular order and thus do not show flow arrows. The user, who may be the flipper, a lender or a third party consultant records the project scope in the system 210. The user, or the system determines as-repaired value (“ARV”) 212. This may be done automatically by the system based on publicly available market data or manually entered by the user. The system estimates profitability 214 or the user does so and enters the information into the system. The system records the flipper's past history of transactions 216, this information is useful to lenders and contractors, for example. The system records loan details, both as proposed to the flipper and once accepted 218. The system allows the contractor, flipper or work inspector to capture and record in the blockchain inspection video 220. The system allows the inspector to record an inspection report 222. The system records draw authorizations 224. The system records subcontractor invoices 226. The system facilitates payments to the subcontractors either directly from the lender, through the flipper or through a general contractor, once inspection goals are met 228. The system provides for on-property marketing 230 wherein the flipper will be able to post the property on the system web site for marketing purposes. The system also allows potential buyers to see “behind the walls” stages of the project 232. The system allows buyers to search projects in process either by flipper, by contractor or system-wide 234.

The blockchain may be enabled to manage information used to underwrite a loan for acquisition of real property and planned improvements. The blockchain may be enabled in a draw schedule for funds disbursement as milestones are achieved, record funds transfers based on achievement of milestones, with optional transfers directly from lender to vendors, record payments made by the borrower, and record the loan payoff. The blockchain may be enabled to record proof of delivery of material, labor, or other services that improve a property and to record payments for delivery of material, labor, or other services. Proof may include digital scans or photos of delivery documentation, digital recording of acceptance of delivery, or photo or video documentation with embedded location information. The blockchain may be enabled to manage a network of verifiers who review documentation related to delivery of material, labor, or other services that improve a property and to record results for use in authorizing payment. The blockchain system maintains information about verifiers, including performance reviews, for use in manual or automated routing of requests for verification. The blockchain system manages payment of verifiers. The blockchain may be enabled to record evidence of improvements on a property, including photo and video documentation of in progress and completed work. The blockchain system also provides evidence of vendor payment for improvements. The blockchain system also records any applicable warranties for material, labor, or other services that improve a property. The blockchain may be enabled to calculate the value of property prior to improvement and calculate an ARV based on factors including scope of work and comparable sales. The system may record results along with data used for calculation to support lender underwriting and compliance.

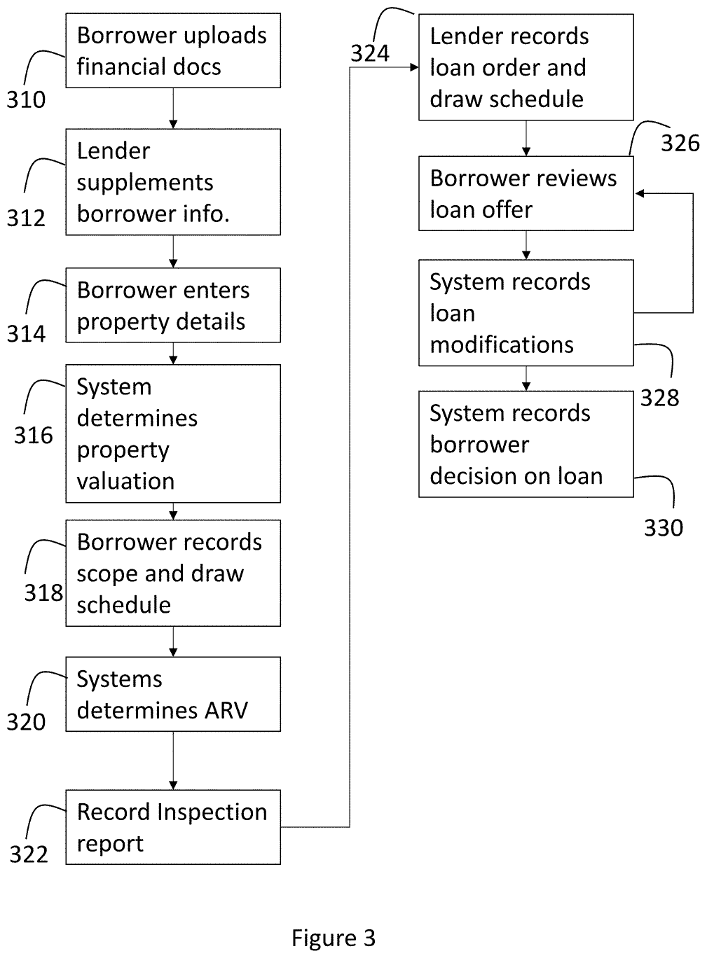

FIG. 3 is an exemplary loan underwriting process diagram. At step 310, the borrower uploads financial documents required by lender (e.g., tax return, bank statements, existing loan docs). At step 312, the lender or third party(ies) verify and/or supplement borrower information and records results. At step 314, the borrower records property details and valuation. Optionally, as shown in step 316, the system calculates and records property valuation. At step 318, the borrower records project scope and draw schedule (either system default or proposed alternative). Optionally, as shown at step 320, the system calculates and records after repair value (ARV). At step 322, the lender accesses borrower financial position and payment history, property details and valuation, and project scope and ARV. At step 324, the lender records a loan offer, including draw schedule. At step 326, the borrower reviews the loan offer and accepts, declines, or requests modification. At step, 328, if needed, the system manages and records communication(s) regarding modification(s). At step 330, the system records the borrower decision whether to proceed with the loan or not. All information is either recorded directly in a blockchain system or stored externally with a hash of the information stored in a blockchain

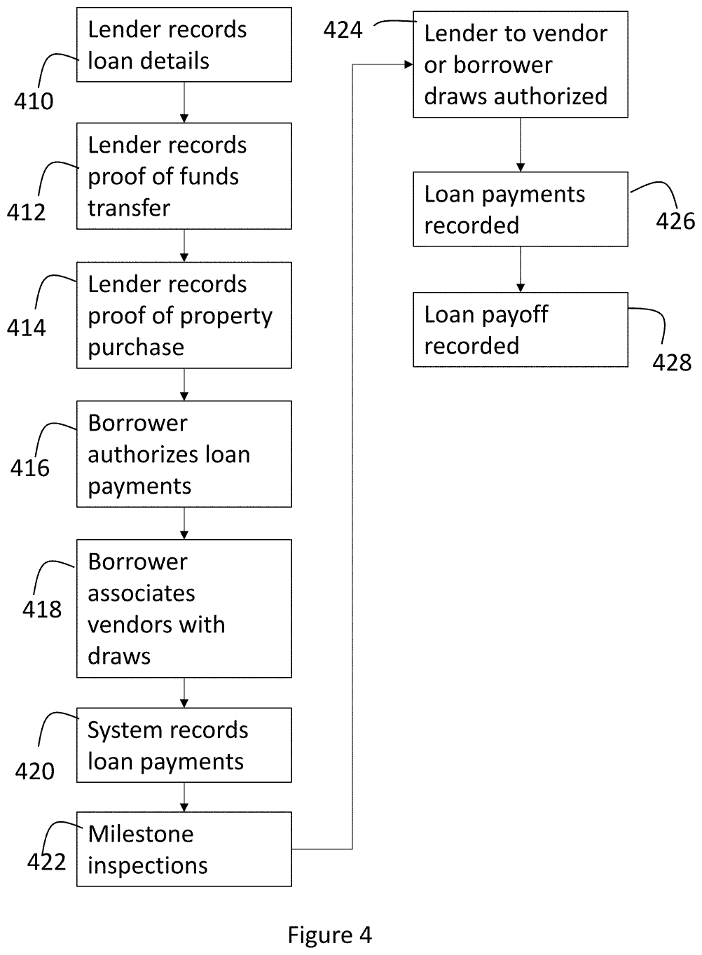

FIG. 4 is an exemplary loan administration process diagram consistent with embodiments described herein. At step 410, the lender records loan details (and any related documents), including draw schedule. These may be pre-populated as a result of the underwriting process. At step 412, the lender records proof of funds transfer. At sept 414, the lender records proof of property purchase. At step 416, the lender specifies a loan payment schedule. At step 418, the borrower authorizes loan payments to be made through system. At step 420, if required by the lender, the borrower associates a specific vendor or vendors (and amounts) with each draw. These may be updated over time with approval of lender. At step 422, the system records loan payments and updates borrower payment history for use in underwriting future loans. At step 424, milestone inspections are performed, and results recorded (see optional Remote Inspection). At step 426, if draw requirements are met, the system initiates (or executes) and records payment from lender to borrower (or vendor(s), if specified) for draw amount. At step 428, the lender or borrower record loan payoff (and any related documents such as title changes). All information is either recorded directly in a blockchain system or stored externally with a hash of the information stored in a blockchain.

As noted above, many lenders require milestone inspections during a fix and flip project. There can be as many as six to eight of these. Flippers pay $150 to $300 for each inspection and must wait for inspection to be completed before receiving next loan draw. Consistent with embodiments described herein, an exemplary system uses smartphone video, GPS, remote reviews, and blockchain records to reduce inspection fees and wait times.

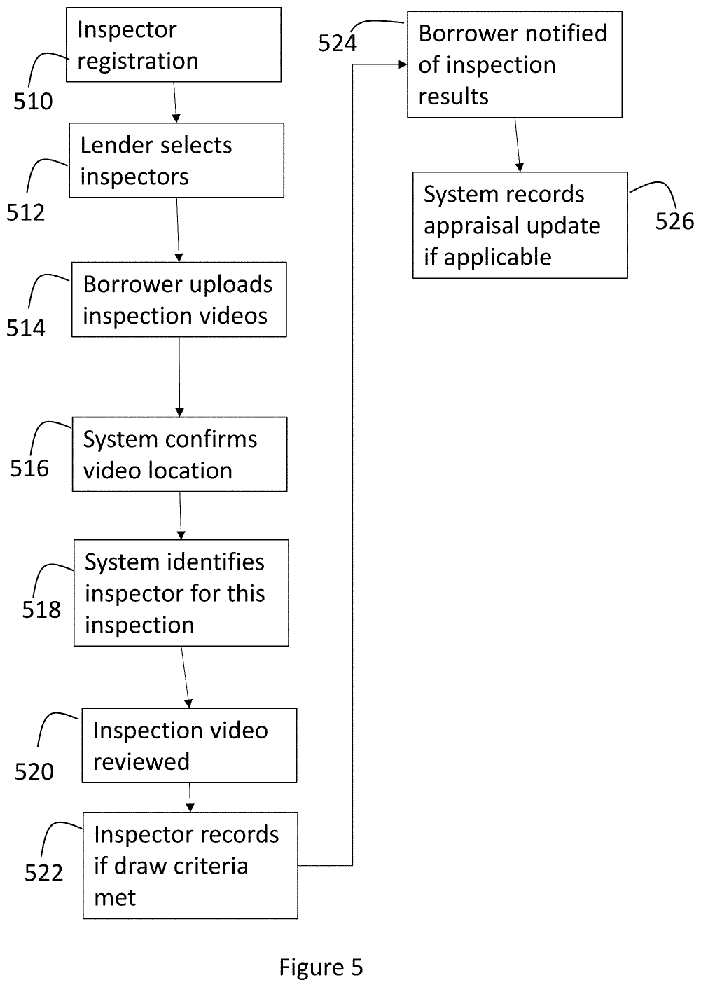

FIG. 5 is an exemplary remote progress inspection process diagram consistent with embodiments described herein. At step 510, potential inspectors register with the system and provide their credentials. Credentials are recorded in the system and optionally verified by the system or operator. At step 512, the lender optionally selects inspectors eligible for their properties or specifies criteria the system may use for auto-selecting inspectors. At step 514, the borrower (or their agent) uploads inspection video(s) for draw in draw schedule. Location of video(s) is identified via GPS, Bluetooth, WiFi, and/or other means and is embedded in metadata of video(s). At step 516, the system confirms that the video location corresponds with property location. At step 518, the system optionally identifies inspector using lender's list or criteria. At step 520, the lender (or their agent) reviews inspection video. At step 522, an inspector records if draw requirements are met. At step 524, the system notifies the borrower of inspection results. At step 526, the system optionally generates, records, and distributes an Appraisal Update and/or Completion Report (Fannie Mae Form 1004d). All information is either recorded directly in a blockchain system or stored externally with a hash of the information stored in a blockchain.

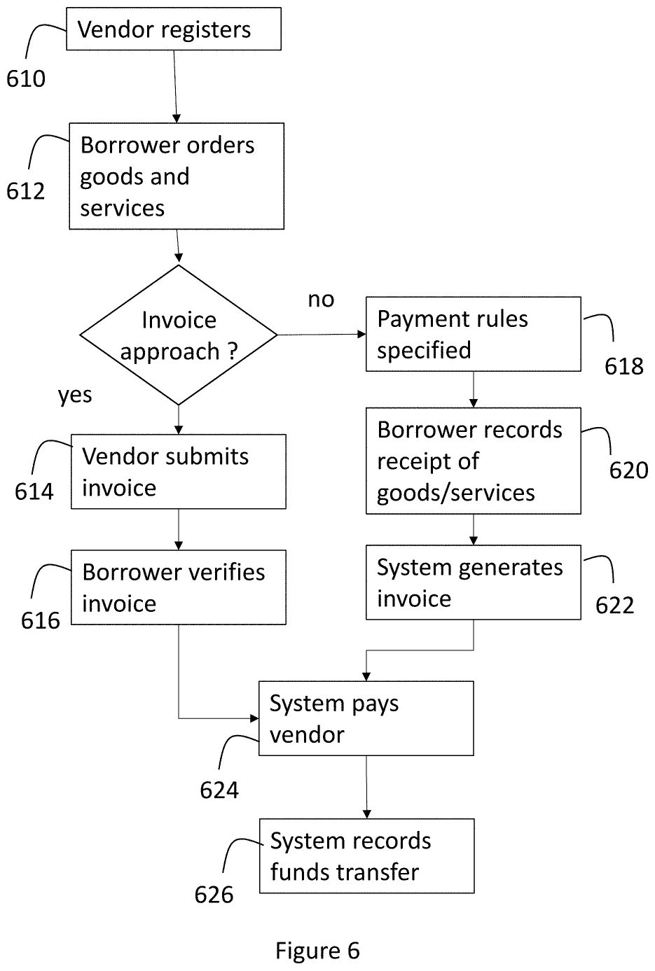

FIG. 6 is an exemplary vendor payment process diagram consistent with embodiments described herein. At step 610, a vendor registers business and bank details in the system. At step 612, the borrower orders goods/services through the system (likely based on quote) and specifies payment terms. At step 614 if using an invoice approach the vendor records the invoice directly into system or uploads invoice along with invoice total. At step 616, the borrower verifies that the invoice matches the goods/services delivered. At step 618, if a no invoice approach is used, payment rules (e.g., net 30 days) are specified. At step 620, in the no invoice approach, the borrower records receipt of goods or services or an inspector confirms services completed. At step 622 in the no invoice approach, the system generates invoice (if needed) for records. At step 624, under either approach, the system pays the vendor based on payment terms. At step 626, when a vendor is associated with a draw in a draw schedule and the draw is approved, system initiates (or executes) and records a transfer directly from the lender to the vendor. Otherwise, the system initiates transfer from borrower to vendor.

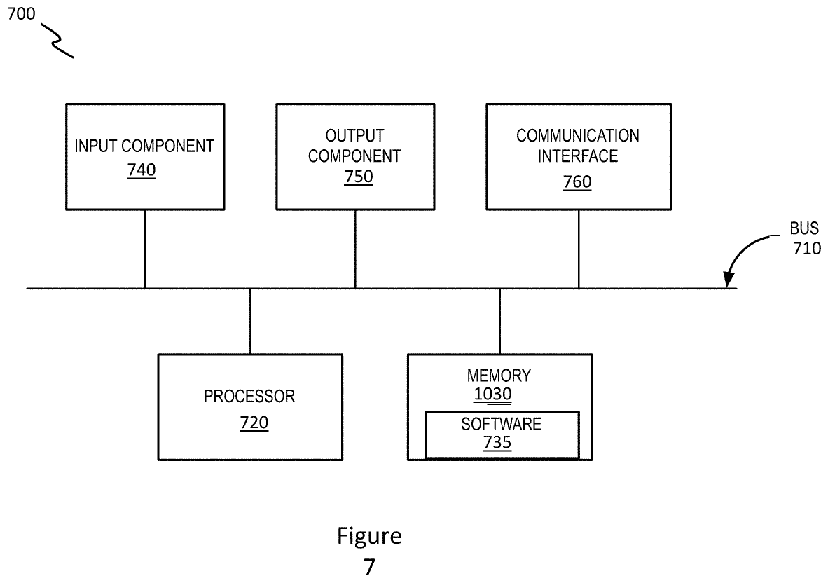

FIG. 7 is a diagram illustrating exemplary physical components of a device 700. Device 700 may correspond to various devices within the above-described system, such as a system controller. Device 700 may include a bus 710, a processor 720, a memory 730, an input component 740, an output component 750, and a communication interface 760.

Bus 710 may include a path that permits communication among the components of device 700. Processor 720 may include a processor, a microprocessor, or processing logic that may interpret and execute instructions. Memory 730 may include any type of dynamic storage device that may store information and instructions, for execution by processor 720, and/or any type of non-volatile storage device that may store information for use by processor 720.

Software 735 includes an application or a program that provides a function and/or a process. Software 735 is also intended to include firmware, middleware, microcode, hardware description language (HDL), and/or other form of instruction. By way of example, with respect to the network elements that include logic to provide proof of work authentication, these network elements may be implemented to include software 735. Additionally, for example, device 700 may include software 735 to perform tasks as described above with respect to FIGS. 2-6.

Input component 740 may include a mechanism that permits a user to input information to device 700, such as a keyboard, a keypad, a button, a switch, etc. Output component 750 may include a mechanism that outputs information to the user, such as a display, a speaker, one or more light emitting diodes (LEDs), etc.

Communication interface 760 may include a transceiver that enables device 700 to communicate with other devices and/or systems via wireless communications, wired communications, or a combination of wireless and wired communications. For example, communication interface 760 may include mechanisms for communicating with another device or system via a network. Communication interface 760 may include an antenna assembly for transmission and/or reception of RF signals. In one implementation, for example, communication interface 760 may communicate with a network and/or devices connected to a network. Alternatively or additionally, communication interface 760 may be a logical component that includes input and output ports, input and output systems, and/or other input and output components that facilitate the transmission of data to other devices.

Device 700 may perform certain operations in response to processor 720 executing software instructions (e.g., software 735) contained in a computer-readable medium, such as memory 730. A computer-readable medium may be defined as a non-transitory memory device. A non-transitory memory device may include memory space within a single physical memory device or spread across multiple physical memory devices. The software instructions may be read into memory 730 from another computer-readable medium or from another device. The software instructions contained in memory 730 may cause processor 720 to perform processes described herein. Alternatively, hardwired circuitry may be used in place of or in combination with software instructions to implement processes described herein. Thus, implementations described herein are not limited to any specific combination of hardware circuitry and software.

Device 700 may include fewer components, additional components, different components, and/or differently arranged components than those illustrated in FIG. 7. As an example, in some implementations, a display may not be included in device 700. In these situations, device 700 may be a “headless” device that does not include input component 740. Additionally, or alternatively, one or more components of device 700 may perform one or more tasks described as being performed by one or more other components of device 700.

FIG. 8 is a block diagram of an exemplary system 800 consistent with embodiments described herein, which includes the following elements: Permissioned Blockchain Services 810. Permissioned blockchain services whose members include permissioned business participants, run chaincode or business logic and records/queries data in the permissioned ledger. The public blockchain 812 is a service such as Ethereum® for executing smart contracts in the public permissionless environment and accessing data from the public ledger. Storage Services 814 are a storage environment external to the blockchain for storing documents and other files such as drawings, purchase orders, business contracts, pictures etc. The Public Blockchain API 816 is a representational state transfer (REST API) layer that provides access to smart contract functions in the public blockchain. The Permissioned Blockchain API 818 is a REST API layer that provides access to chaincode functions in the permissioned blockchain. The Cache 820 is a memory and off-chain database to store application specific, PII and non-blockchain data. The Certificate Authority (CA) 822 is responsible for issuing user and organizational credentials. The Application API 824 are REST API services that are specific to the application and can be accessed by external interfaces and clients such as enterprise applications and user interfaces. The Application Services 826 are technical services provided by the Application API 824. The Client Interface 828 is an interface via which users will access the application such as desktop or mobile user interfaces. Enterprise Applications 830 are applications that run within corporate environments for processing intra-enterprise business transactions. The AI/ML 832 is a Machine learning and Analytics engine that receives insights from data stored within the external data stores and the blockchain ledgers. The interfaces labeled JSON are JavaScript Object Notation interfaces. The interface labeled GRPC a remote procedure call.

Although the invention has been described in detail above, it is expressly understood that it will be apparent to persons skilled in the relevant art that the invention may be modified without departing from the spirit of the invention. Various changes of form, design, or arrangement may be made to the invention without departing from the spirit and scope of the invention. Therefore, the above-mentioned description is to be considered exemplary, rather than limiting, and the true scope of the invention is that defined in the following claims.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

What is claimed is:

1. A computing system configured to enable real estate purchase, renovation and sale transactions via a blockchain, the system comprising:
a shared database configured to store said blockchain;
input devices configured to allow renovators, lenders, vendors and inspectors to record aspects of the purchase, renovation and sale of the real estate in the blockchain.

2. The computing system of claim 1, wherein said shared database is accessible via the Internet.

3. The computing system of claim 1, wherein said input devices access the blockchain via the Internet.

4. The computing system of claim 1, further configured to record in the blockchain the underwriting of a loan for acquisition of real property and planned improvements.

5. The computing system of claim 1, further configured to record in the blockchain a draw schedule for funds disbursement as milestones are achieved, funds transfers based on achievement of milestones, record transfers directly from the lender to the vendor, payments made by the borrower, or loan payoff.

6. The computing system of claim 1, further configured to record in the blockchain proof of delivery of material, labor, or other services that improve a property and to record payments for delivery of material, labor, or other services, wherein said proof may include digital scans or photos of delivery documentation, digital recording of acceptance of delivery, or photo or video documentation with embedded location information.

7. The computing system of claim 1, further configured to manage a network of verifiers who review documentation related to delivery of material, labor, or other services that improve a property and to record results for use in authorizing payment and to maintains information about verifiers, including performance reviews, for use in manual or automated routing of requests for verification.

8. The computing system of claim 1 further configured to enable payment of verifiers.

9. The computing system of claim 1 further configured to record evidence of improvements on a property, including photo and video documentation of in progress and completed work.

10. The computing system of claim 1 further configured to evidence of vendor payment for improvements.

11. The computing system of claim 1 further configured to record in the blockchain warranties for material, labor, or other services that improve a property.

12. The computing system of claim 1 further configured to calculate value of property prior to improvement and calculate an ARV based on factors including scope of work and comparable sales.

13. The computing system of claim 12 further configured to record said ARV and factors results along with data used for calculation in the blockchain.
